(19) United States
(12) Patent Application Publication
(10) Pub. No.: US 2015/0040446 A1
(43) Pub. Date: Feb. 12, 2015

(54) OUTDOOR UNIT AND AIR-CONDITIONING APPARATUS

(71) Applicant: Mitsubishi Electric Corporation, Tokyo (JP)

(72) Inventors: Jiro NAKASU, Tokyo (JP); Hiroaki MAKINO, Tokyo (JP); Minoru ISHII, Tokyo (JP); Kenta KAWAHARA, Tokyo (JP); Wataru YAMADA, Tokyo (JP); Takahiro YAMAGUCHI, Tokyo (JP)

(21) Appl. No.: 14/451,808

(22) Filed: Aug. 5, 2014

(30) Foreign Application Priority Data
Aug. 7, 2013 (JP) 2013-164381

(51) Int. Cl. G09F 3/02; G09F 3/10; F25D 23/06

(52) U.S. Cl. CPC G09F 3/02; F25D 23/065; G09F 3/10
USPC 40/625; 40/299.01; 40/662

(57) ABSTRACT

In an outdoor unit, at least the name of a refrigerant used is indicated on the outer side of a cover.

### TECHNICAL FIELD

The present invention relates to an outdoor unit of an air-conditioning apparatus including a compression refrigeration cycle, and particularly, it relates to an outdoor unit and an air-conditioning apparatus each providing improved safety and reliability during installation of the air-conditioning apparatus and during service work performed on the air-conditioning apparatus.

### BACKGROUND ART

Conventionally, refrigerants such as R22 that is based on hydrochlorofluorocarbon (HCFC) and R410A that is based on hydrofluorocarbon (HFC) have often been used in air-conditioning apparatuses. Many current and conventional air-conditioning apparatuses employ R22 or R410A. In Japan, apparatuses employing R410A are currently the mainstream. Even taking conventional air-conditioning apparatuses into account, apparatuses employing R410A are considered to be dominant.

However, from the recent-year viewpoints of ozone layer protection and global warming prevention, attention has come to be paid to the following refrigerants: R32 (difluoromethane), which is a flammable HFC-based refrigerant; hydrofluoro-olefin-based refrigerants (such as HFO1234yf and HFO1234ze); refrigerant mixtures containing R32 and any HFO-based refrigerant; and natural refrigerants such as R290 (propane) and R600a (isobutane). In particular, HFC-based R32 and HC-based R290 (propane) have come to attract attention as substitutes for other refrigerants. The refrigerants R32 and R290 have far smaller global warming potentials (GWP), when emitted into the atmosphere, than other refrigerants such as R22 and R410A.

However, since the refrigerants such as R32 and R290 are flammable, products employing such refrigerants need to be designed with full consideration for safety. The refrigerant R290 is highly flammable and needs to be handled with special care. The refrigerant R32 is less flammable than the refrigerant R290 and is therefore applicable to a product design that is relatively similar to that intended for a non-flammable refrigerant such as R22 or R410A. Nevertheless, the refrigerant R32 is flammable, and safety design is necessary. Therefore, if a flammable refrigerant such as R32 or R290 is employed, a certain amount of costs need to be spent on safety improvement.

An air-conditioning apparatus includes a compression refrigeration cycle in which a compressor, an outdoor heat exchanger, an indoor heat exchanger, a four-way valve, a pressure reducing device, and other devices are connected to one another by refrigerant pipes. Hence, in a case where the air-conditioning apparatus employs a flammable refrigerant such as R32 or R290, safety design is particularly necessary in view of situations in which the refrigerant is charged into the refrigerant circuit, for example, during installation of the air-conditioning apparatus or during service work (such as maintenance work or repair work) performed on the air-conditioning apparatus.

As an example of such an air-conditioning apparatus, the following has already been disclosed (see, for example, Patent Literature 1): “a cooling apparatus having an injection port from which a refrigerant is charged into a refrigerant circuit, the apparatus comprising an indication portion on which the kind of the refrigerant used is indicated, the indication portion being provided in the vicinity of the injection port.”

In another known air-conditioning apparatus, the name of the refrigerant is given on a product identification label that is attached on an outdoor unit.

### CITATION LIST

### Patent Literature

[Patent Literature 1] Japanese Unexamined Patent Application Publication No. 10-311629 (see FIG. 2 and so forth)

### SUMMARY OF INVENTION

### Technical Problem

As described above, many kinds of refrigerants are used in various air-conditioning apparatuses. If the refrigerants specified for the individual air-conditioning apparatuses are not used, the air-conditioning apparatuses may cause failure. Moreover, since some refrigerants are flammable as described above, precaution needs to be provided in some cases so as to keep the refrigerant away from flames while the refrigerant is being charged. Hence, it is highly important to assuredly notify the worker of the name of the refrigerant used, and to provide precaution in performing work.

In the technique disclosed by Patent Literature 1, an indication of the kind of the refrigerant used is provided as a reminder in the vicinity of the injection port (a charge port) from which the refrigerant is charged, whereby the kind of the refrigerant is notified to the worker. However, some apparatuses do not have enough spaces for attaching labels in the vicinity of the injection ports, as illustrated in FIG. 2 of Patent Literature 1. In such a case, precaution in performing work cannot additionally be provided.

In an air-conditioning apparatus provided with a product identification label having the refrigerant name, the refrigerant name is provided along with various standards and specifications of the apparatus. Therefore, the space for indication is limited, and such pieces of information can only be printed in small letters. Consequently, the worker may overlook important information.

Moreover, depending on the place of installation, any of the above air-conditioning apparatuses may have to be installed in an unfavorable situation (in which, for example, the work place is dim, or the worker needs to perform work in an unnatural posture). Therefore, the worker may overlook the indication and may use a wrong refrigerant.

Particularly, in a case where a flammable refrigerant such as R32 or R290 is used, safety cannot assuredly be provided unless the possibility of overlooking is completely eliminated even if the worker has to perform installation work under any unfavorable conditions. Hence, it is necessary to fully notify the worker of the kind of the refrigerant used in a more reliable way than ever.

Furthermore, as the use of substitutional refrigerants is promoted hereafter, the number of kinds of refrigerants to be handled will increase. Consequently, the probability that the worker who performs service work may charge a wrong refrigerant by mistake is considered to increase. In such an event, there may be a great loss of safety and reliability, disadvantageously.

The security design for flammable refrigerants is not applied to, for example, conventional air-conditioning apparatuses intended for the refrigerant R22 or R410A. Suppose that a flammable refrigerant is mistakenly charged into such a conventional air-conditioning apparatus. Here, if the refrigerant leaks while installation work or service work is being performed or if the refrigerant leaks because of any damage to the refrigerant circuit while the air-conditioning apparatus is being used, the density of the refrigerant in the ambient air may reach a level at which the air can catch fire. If there is any ignitable matter in such a situation, the refrigerant may catch fire, leading to a serious incident.

On the other hand, if the refrigerant R22 or R410A is mistakenly charged into an air-conditioning apparatus that is intended for a flammable refrigerant, the inside of the compressor may wear or the cooling or heating performance may be deteriorated, significantly reducing the reliability. This is because, for example, the kind of the refrigerating machine oil is selected particularly carefully in accordance with the kind of the refrigerant.

To avoid charging a wrong refrigerant during installation of the air-conditioning apparatus or during service work performed on the air-conditioning apparatus, the diameter of a refrigerant charging port in a charge portion may be changed in accordance with the kind of the refrigerant, which can be taken as an easy countermeasure against the charging of a wrong refrigerant. However, if the diameter of the refrigerant charging port in the charge portion is changed in accordance with the kind of the refrigerant, the types of a charging hose for charging the refrigerant, a container (cylinder) for storing the refrigerant, and other associated components for vacuuming the refrigerant circuit also need to be changed. Accordingly, the worker who performs the installation work or service work needs to prepare new equipment that match the changed devices, leading to a significant cost increase. Moreover, if the worker goes to such an installation site or a service site without bringing the new equipment, the worker cannot perform the expected work, leading to a serious trouble.

In April 2001, the Home Appliance Recycling Law was enforced. In compliance with this law, a large number of waste products including air-conditioning apparatuses, refrigerators, and televisions are collected to recycling centers. In such a recycling center, the waste products are subject to disassembling work and sorting/classifying work performed manually by workers, product crashing work performed by using a crasher, and sorting/classifying work for sorting/classifying the resulting materials into iron, copper, aluminum, plastic, and other categories by using a sorter/classifier. In addition, in the recycling center, if the waste products include any air-conditioning apparatuses, the refrigerant contained in each of the air-conditioning apparatuses is collected by workers.

Iron, copper, and aluminum melt in a high-temperature treatment and are easy to reuse because the influence of foreign substances, impurities, contaminants, or the like adhered thereto is small. Hence, the foregoing materials are reused as valuables. Plastic materials are of various kinds and have various colors, which makes it difficult to recycle plastic materials. Nevertheless, sorting/classifying of plastic materials has become possible in recent years, and many plastic materials have been reused.

Furthermore, the Act on Ensuring the Implementation of Recovery and Destruction of Fluorocarbons concerning Designated Products was partially revised in April 2013. With this revision, there is a society trend of requiring efforts to recycle used fluorocarbons. Hence, in the recycle center, collection of refrigerants with increased purity is required so that the recycling and reuse of the collected refrigerants are facilitated.

The present invention is to overcome the above problems and provides an outdoor unit and an air-conditioning apparatus each providing increased safety and reliability by assuredly notifying workers (workers who perform installation work, service work, and recycling work) of the kind of the refrigerant used.

### Solution to Problem

According to one aspect of the present invention, an outdoor unit includes a cover attached to a side panel thereof. At least a name of a refrigerant used in the outdoor unit is indicated on at least one of an outer side and an inner side of the cover.

According to a second aspect of the present invention, an air-conditioning apparatus includes the above outdoor unit, and an indoor unit that is connected to the outdoor unit.

### Advantageous Effects of Invention

With the outdoor unit according to the first aspect of the present invention, the probability that the worker may overlook the indication of the refrigerant name when performing any work involving the handling of the refrigerant can be reduced.

Since the air-conditioning apparatus according to the second aspect of the present invention includes the above outdoor unit, the probability that the worker may overlook the indication of the refrigerant name is reduced. Consequently, the reduction in the performance and quality of the air-conditioning apparatus can be suppressed.

### BRIEF DESCRIPTION OF DRAWINGS

FIG. 1 is a schematic diagram illustrating the overall configuration of an air-conditioning apparatus including an outdoor unit according to Embodiment 1 of the present invention.

FIG. 2 is an exploded perspective view illustrating an indoor unit of the air-conditioning apparatus including the outdoor unit according to Embodiment 1 of the present invention.

FIG. 3 is an exploded perspective view of the outdoor unit according to Embodiment 1 of the present invention.

FIG. 4 is an enlarged view illustrating a part of a lateral side face of the outdoor unit according to Embodiment 1 of the present invention.

FIG. 5 illustrates steps of charging a refrigerant.

FIG. 6 is a perspective view illustrating the appearance of the outdoor unit according to Embodiment 1 of the present invention.

FIG. 7 illustrates an exemplary known outdoor unit.

FIG. 8 illustrates another exemplary known outdoor unit.

FIG. 9 is a perspective view illustrating the appearance of an outdoor unit according to Embodiment 2 of the present invention.

FIG. 10 illustrates an outdoor unit according to Embodiment 3 of the present invention.

FIG. 11 illustrates an outdoor unit according to Embodiment 4 of the present invention.

FIG. 12 illustrates an outdoor unit according to Embodiment 5 of the present invention.

FIG. 13 illustrates an outdoor unit according to Embodiment 6 of the present invention.

FIG. 14 illustrates a cover attached to an outdoor unit according to Embodiment 7 of the present invention.

FIG. 15 illustrates an outdoor unit according to Embodiment 8 of the present invention.

### DESCRIPTION OF EMBODIMENTS

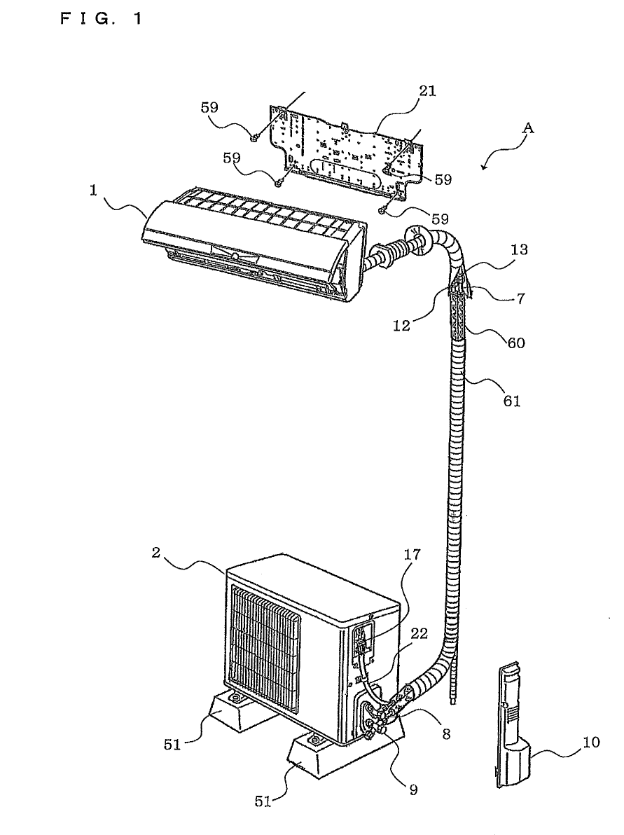

Embodiments of the present invention will now be described with reference to the drawings. In the drawings including FIG. 1 to be referred to below, elements illustrated are not necessarily scaled in accordance with the relationship of their actual sizes. Furthermore, in the drawings including FIG. 1 to be referred to below, like reference numerals denote like or equivalent elements, which applies to the entirety of the specification. The modes of the elements described herein are merely of exemplary descriptions that should never be read as unnecessarily limitative.

### Embodiment 1

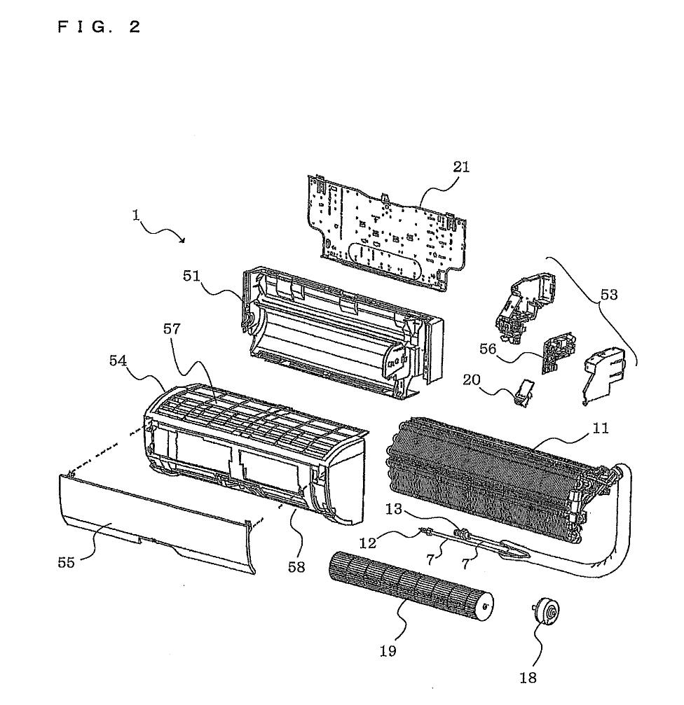

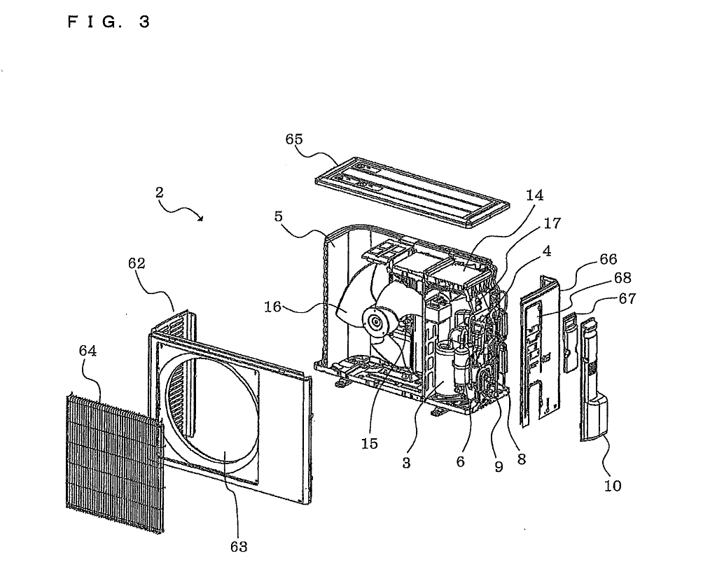

FIG. 1 is a schematic diagram illustrating the overall configuration of an air-conditioning apparatus A including an outdoor unit 2 according to Embodiment 1 of the present invention. FIG. 2 is an exploded perspective view of an indoor unit 1. FIG. 3 is an exploded perspective view of the outdoor unit 2. A configuration of the air-conditioning apparatus A will now be described with reference to FIGS. 1 to 3. The outdoor unit 2 is intended to assuredly notify the worker (for example, the worker who installs the air-conditioning apparatus A, the worker who removes the air-conditioning apparatus A, the worker who performs service work on the air-conditioning apparatus A, or the worker who recycles the air-conditioning apparatus A) of the kind of a refrigerant that is contained in the air-conditioning apparatus A.

The air-conditioning apparatus A is applied to, for example, a separate-type home-use air-conditioner and includes the indoor unit 1 and the outdoor unit 2. The indoor unit 1 is fixed by being hung on an installation plate 21 that is fixed to, for example, an indoor-side wall with screws 59 or the like. The indoor unit 1 supplies conditioned air into an air-conditioning target space. The outdoor unit 2 is fixed on supporting blocks 51 provided in a space (for example, an outdoor space) that is separate from the air-conditioning target space. The outdoor unit 2 supplies cooling energy or heating energy to the indoor unit 1. The outdoor unit 2 is preferably installed at, for example, a position where an air passage is assuredly provided during operations and that is not too far from the indoor unit 1.

A liquid-side pipe-connecting joint 12 and a gas-side pipe-connecting joint 13 are connected to the indoor unit 1. A liquid-side pipe-connecting valve 8 and a gas-side pipe-connecting valve 9 are connected to the outdoor unit 2. The liquid-side pipe-connecting joint 12 of the indoor unit 1 and the liquid-side pipe-connecting valve 8 of the outdoor unit 2 are connected to each other by a flared extension pipe (refrigerant pipe) 7. Likewise, the gas-side pipe-connecting joint 13 of the indoor unit 1 and the gas-side pipe-connecting valve 9 of the outdoor unit 2 are connected to each other by another flared extension pipe 7. Thus, devices included in the indoor unit 1 and devices included in the outdoor unit 2 are connected to each other by the pipes, whereby a refrigerant circuit is provided.

To electrically connect the indoor unit 1 and the outdoor unit 2 to each other, a terminal block 20 of the indoor unit 1 and a terminal block 17 of the outdoor unit 2 are connected to each other by a vinyl-insulated vinyl-sheathed flat-type (VVF) cable 22. The liquid-side pipe-connecting valve 8, the gas-side pipe-connecting valve 9, and the terminal block 17 of the outdoor unit 2 are provided at positions where the intended work is performable by detaching a cover 10 from the outdoor unit 2. That is, the cover 10 is detachably attached to a lateral side face of the outdoor unit 2.

(Indoor Unit 1)

The indoor unit 1 includes a base 52, an indoor heat exchanger 11, an indoor blower motor 18, an blower fan 19, an electric component box 53, a casing 54, and an openable/closable and detachable front design panel 55. The base 52 is fixed to the installation plate 21. The indoor heat exchanger 11, the indoor blower motor 18, the blower fan 19, the electric component box 53, and the terminal block 20 are attached to the base 52. In this state, the casing 54 is screwed to the base 52. That is, the indoor heat exchanger 11, the indoor blower motor 18, the blower fan 19, the electric component box 53, and the terminal block 20 are covered with the casing 54. The front design panel 55 is attached to the casing 54.

The indoor heat exchanger 11 functions as a condenser (radiator) in a heating operation and as an evaporator in a cooling operation. The indoor blower motor 18 and the blower fan 19 are provided on the front side of the indoor heat exchanger 11 and send air toward the indoor heat exchanger 11. The electric component box 53 houses an indoor-side driving device 56 that drives the indoor blower motor 18. The terminal block 20 electrically connects the indoor unit 1 to the outdoor unit 2.

The indoor unit 1 has an air inlet 57 from which air in the air-conditioning target space is taken. The air inlet 57 is provided in the upper face of the casing 54. The indoor unit 1 also has an air outlet 58 provided in a lower front portion of the casing 54. The air taken from the air inlet 57 passes through the indoor heat exchanger 11, where the air undergoes heat exchange. Then, the conditioned air is blown from the air outlet 58 into the air-conditioning target space.

(Outdoor Unit 2)

The outdoor unit 2 includes a compressor 3 that compresses the refrigerant and is of, for example, a variable-rotation-speed type, a four-way valve 4 that switches the flow of the refrigerant, an outdoor heat exchanger 5 that functions as an evaporator in the heating operation and as a condenser (radiator) in the cooling operation, a flow rate control device 6 (a pressure reducing device) that reduces the pressure of the refrigerant, and an outdoor blower motor 15 and an outdoor fan 16 that send air toward the outdoor heat exchanger 5. The outdoor unit 2 has a casing that includes a panel 62 forming the front face and one lateral side face, a top plate 65 forming the top face, and a side panel 66 forming another lateral side face.

The panel 62 has an opening 63 at a position facing the outdoor fan 16. The opening 63 allows air to pass therethrough. A fan guard 64 that is formed of wires is provided over the opening 63. The side panel 66 has an opening 68 from which the VVF cable 22 is exposed to the outside. The VVF cable 22 exposed from the opening 68 of the side panel 66 is covered with a cable cover 67. The cable cover 67 also protects the liquid-side pipe-connecting valve 8, the gas-side pipe-connecting valve 9, and the terminal block 17 and is further covered with the cover 10 so that the end user is prevented from carelessly touching the foregoing elements. The outdoor unit 2 also includes a driving device 14 that drives the compressor 3, the four-way valve 4, and the outdoor blower motor 15; and the terminal block 17 that electrically connects the outdoor unit 2 to the indoor unit 1.

(Refrigerant Circuit)

The indoor heat exchanger 11 of the indoor unit 1 is connected to the compressor 3, the four-way valve 4, the outdoor heat exchanger 5, and the flow rate control device 6 of the outdoor unit 2 by the pipes, whereby a refrigerant circuit is provided. Specifically, the refrigerant circuit is configured such that the refrigerant flows through the compressor 3, the four-way valve 4, the indoor heat exchanger 11, the flow rate control device 6, and the outdoor heat exchanger 5 in that order in the heating operation, whereas the refrigerant flows through the compressor 3, the four-way valve 4, the outdoor heat exchanger 5, the flow rate control device 6, and the indoor heat exchanger 11 in that order in the cooling operation. The four-way valve 4 may be omitted so that only one of the cooling operation and the heating operation is performed. The four-way valve 4 may be replaced with, for example, a plurality of two-way valves or three-way valves that are configured to be capable of switching the flow of the refrigerant in the same way.

(Refrigerant)

Examples of the refrigerant that is allowed to circulate through the refrigerant circuit of the air-conditioning apparatus A include the flammable refrigerant R32. However, the refrigerant to be used in the air-conditioning apparatus A is not limited to R32. For example, any of the following refrigerants may be employed: other flammable refrigerants (such as R290); natural refrigerants such as carbon dioxide (CO₂), hydrocarbons, and helium; and chlorine-free refrigerants including alternative refrigerants such as R407C and R404A, as well as R410A.

(Method of Installing Air-Conditioning Apparatus A)

A method of installing the air-conditioning apparatus A will now be described.

First, the installation plate 21 for fixing the indoor unit 1 is fixed to the indoor-side wall with the screws 59 or the like, and the indoor unit 1 is hung on the installation plate 21. Thus, the indoor unit 1 is fixed.

Then, the outdoor unit 2 is placed at a position where an air passage is assuredly provided during operations and that is not too far from the indoor unit 1 (for example, in a space around the house, on a veranda, on the rooftop, in a garage, in a garden, or in any other like space).

Subsequently, to provide the refrigerant circuit of the air-conditioning apparatus A, the liquid-side pipe-connecting joint 12 of the indoor unit 1 and the liquid-side pipe-connecting valve 8 of the outdoor unit 2 are connected to each other by one of the flared extension pipe 7. Likewise, the gas-side pipe-connecting joint 13 of the indoor unit 1 and the gas-side pipe-connecting valve 9 of the outdoor unit 2 are connected to each other by the other flared extension pipe 7. Furthermore, to electrically connect the indoor unit 1 and the outdoor unit 2 to each other, the terminal block 20 of the indoor unit 1 and the terminal block 17 of the outdoor unit 2 are connected to each other by the VVF cable 22.

Subsequently, the cover 10 is attached to the lateral side face of the outdoor unit 2, whereby the liquid-side pipe-connecting valve 8, the gas-side pipe-connecting valve 9, and the terminal block 17 of the outdoor unit 2 are covered.

In general, the two extension pipes 7 are each covered with a heat insulator 60, and the two extension pipes 7 thus covered with the respective heat insulators 60 are bound together with tape 61.

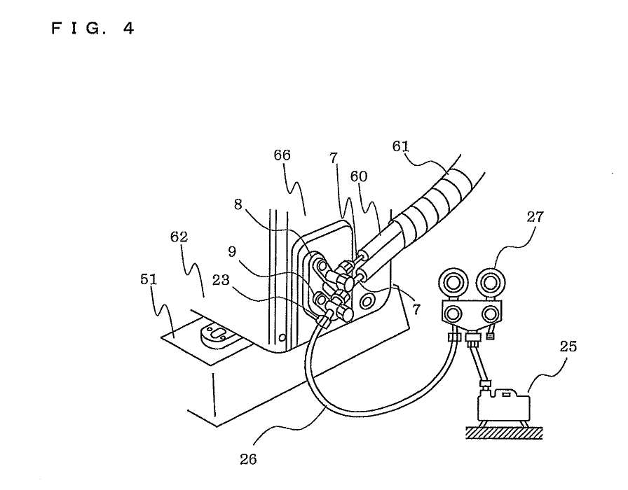

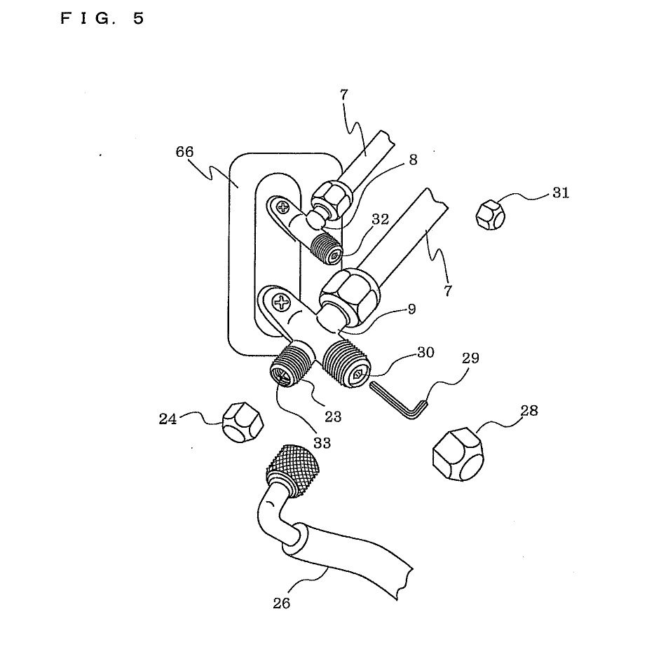

FIG. 4 is an enlarged view illustrating a part of the lateral side face of the outdoor unit 2. FIG. 5 illustrates steps of charging the refrigerant. Typical steps of charging the refrigerant will now be described with reference to FIGS. 4 and 5.

As illustrated in FIG. 4, the gas-side pipe-connecting valve 9 has a refrigerant-charging charge port 23. A charge hose 26 that is connected to a vacuum pump 25 is connected to the refrigerant-charging charge port 23. A pressure gauge 27 is provided between the vacuum pump 25 and the refrigerant-charging charge port 23.

As illustrated in FIG. 5, the gas-side pipe-connecting valve 9 is provided with a gas-pipe-side valve rod 30, in addition to the refrigerant-charging charge port 23. The refrigerant-charging charge port 23 is provided with a sealing hexagonal nut (cap) 24 that seals the refrigerant-charging charge port 23. A push-pin-type valve 33 is provided in the refrigerant-charging charge port 23. The gas-pipe-side valve rod 30 is provided with a valve-rod hexagonal nut (cap) 28. The gas-pipe-side valve rod 30 is operable with a hexagonal wrench 29. The liquid-side pipe-connecting valve 8 is provided with a liquid-pipe-side valve rod 32. The liquid-pipe-side valve rod 32 is provided with a valve-rod hexagonal nut (cap) 31. The liquid-pipe-side valve rod 32 is operable with the hexagonal wrench 29.

In a state where the indoor unit 1 and the outdoor unit 2 are connected to each other by the extension pipes 7, the extension pipes 7 and the pipes included in the indoor heat exchanger 11 of the indoor unit 1 are filled with air. Therefore, the air needs to be released. Hence, on the outdoor unit 2, the sealing hexagonal nut 24 provided over the refrigerant-charging charge port 23 of the gas-side pipe-connecting valve 9 is removed, and the charge hose 26 connected to the vacuum pump 25 is connected to the refrigerant-charging charge port 23. Then, vacuuming is performed. Whether or not the vacuuming is complete is checked by using the pressure gauge 27 or the like.

After the vacuuming is complete, the valve-rod hexagonal nut 28 provided on the gas-side pipe-connecting valve 9 is removed, and the gas-pipe-side valve rod 30 is operated with the hexagonal wrench 29, whereby the gas-side pipe-connecting valve 9 is opened. Likewise, the liquid-side pipe-connecting valve 8 is opened by removing the valve-rod hexagonal nut 31 and operating the liquid-pipe-side valve rod 32 with the hexagonal wrench 29. When the gas-side pipe-connecting valve 9 and the liquid-side pipe-connecting valve 8 are opened, the refrigerant that has been charged into the outdoor unit 2 in advance in a manufacturing process flows into the extension pipes 7 and into the indoor heat exchanger 11. Thus, the indoor unit 1 and the outdoor unit 2 are connected to each other, whereby a refrigerant circuit is provided.

In a case where, for example, the extension pipes 7 are long, the amount of refrigerant that has been charged into the outdoor unit 2 in advance in the manufacturing process may be in sufficient. In such a case, an additional amount of refrigerant needs to be charged. In doing so, the worker charges a required amount of refrigerant from a refrigerant cylinder that has been prepared in advance into the outdoor unit 2 via the refrigerant-charging charge port 23. In this step, the worker needs to carefully check so that there is no error for or disagreement between the kind of the refrigerant contained in the air-conditioning apparatus A and the kind of the refrigerant contained in the prepared refrigerant cylinder.

When the charging of the refrigerant is complete, the worker tightly fastens the valve-rod hexagonal nut 31 onto the liquid-side pipe-connecting valve 8, the valve-rod hexagonal nut 28 onto the gas-side pipe-connecting valve 9, and the sealing hexagonal nut 24 onto the refrigerant-charging charge port 23 by using a wrench. Lastly, the worker attaches the cover 10 to the outdoor unit 2. Thus, a series of work steps are complete.

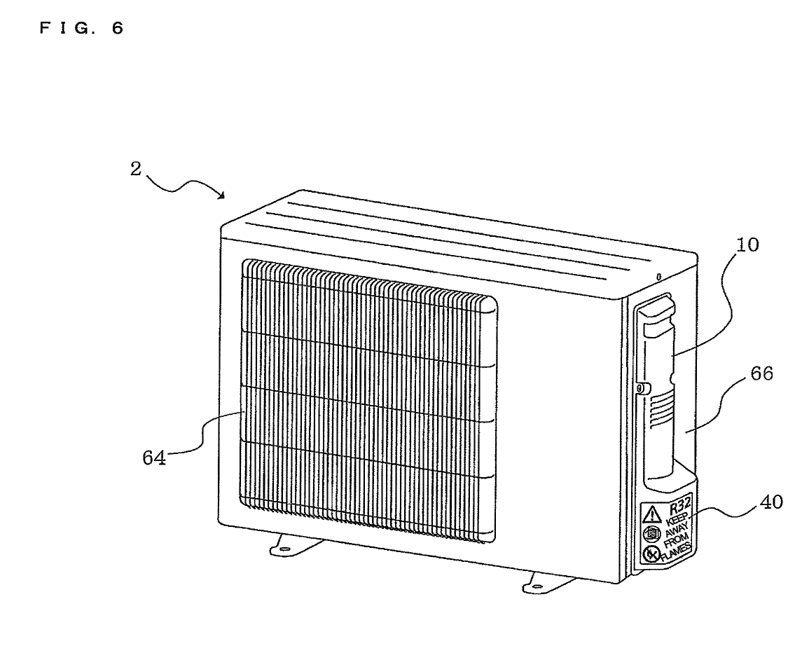

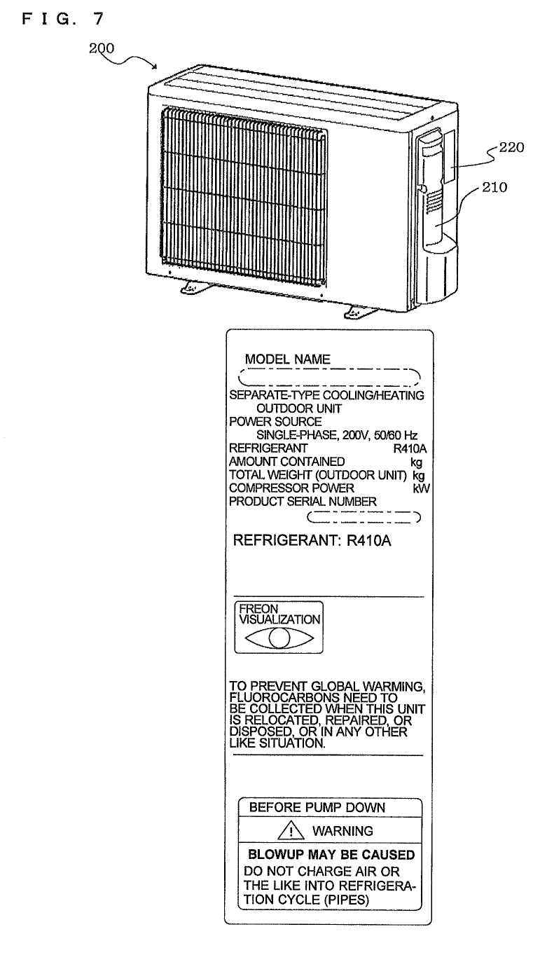

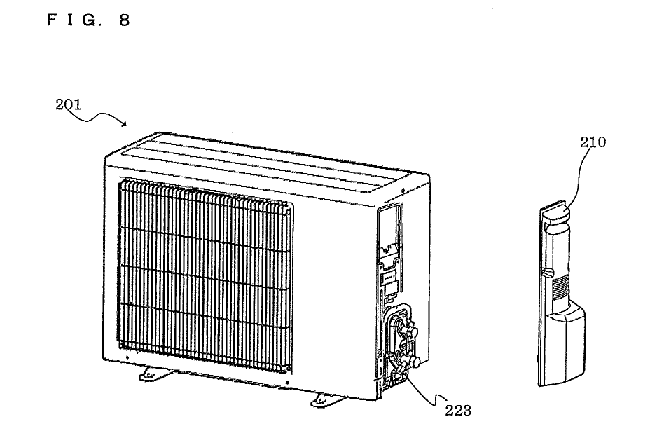

FIG. 6 is a perspective view illustrating the appearance of the outdoor unit 2. FIG. 7 illustrates an exemplary known outdoor unit (hereinafter referred to as outdoor unit 200). FIG. 8 illustrates another exemplary known outdoor unit (hereinafter referred to as outdoor unit 201). The outdoor unit 2 will now be described in detail with reference to FIG. 6 and in comparison with the outdoor unit 200 illustrated in FIG. 7 and the outdoor unit 201 illustrated in FIG. 8, according to need.

As described above, the outdoor unit 2 is intended to assuredly notify the worker of the kind of the refrigerant in the air-conditioning apparatus A when, for example, the worker installs the air-conditioning apparatus A, removes the air-conditioning apparatus A, performs service work on the air-conditioning apparatus A, or recycles the air-conditioning apparatus A. Specifically, with the outdoor unit 2, the probability that the worker may overlook the indication of the refrigerant can be significantly reduced.

The outdoor unit 200 and the outdoor unit 201 each have a cover (hereinafter referred to as cover 210) provided on a lateral side face thereof. The cover 210 has the same function as the cover 10 of the outdoor unit 2. The cover 210 is on the lateral side face of the outdoor unit 200 or 201 when the outdoor unit 200 or 201 is being shipped or used. The cover 210 is detached when any work involving the handling of the refrigerant is performed, for example, during pipe connection to an indoor unit (not illustrated) in the installation work, during pipe disconnection for removal of the outdoor unit 200 or 201, or during charging of the refrigerant.

As with the cover 210, the cover 10 of the outdoor unit 2 is on the lateral side face of the outdoor unit 2 when the air-conditioning apparatus A is being shipped or used. The cover 10 of the outdoor unit 2 is detached when any work involving the handling of the refrigerant is performed, for example, during pipe connection to the indoor unit 1 in the installation of the air-conditioning apparatus A, during pipe disconnection for removal of the air-conditioning apparatus A, or during charging of the refrigerant into the air-conditioning apparatus A.

In the outdoor unit 200 illustrated in FIG. 7, the refrigerant name is provided on a product identification label 220 attached on a side panel 66 of the outdoor unit 200. Therefore, the refrigerant name is provided along with various standards and specifications of the outdoor unit 200. Hence, in the outdoor unit 200, the refrigerant name has to be provided in a limited indication space on the product identification label 220. Therefore, the refrigerant name can be indicated only in small letters, leaving a possibility that the worker may overlook the indication.

In the outdoor unit 201 illustrated in FIG. 8, a label that indicates the refrigerant name is attached in the vicinity of a charge port 223, not on the cover 210. In general, there is only a small space for attaching a label in the vicinity of the charge port 223. Therefore, not more than the refrigerant name can be provided, and precaution in performing work cannot be provided. Hence, with the outdoor unit 201, the possibility that the worker may overlook the refrigerant name cannot be eliminated, and precaution in performing work cannot be notified to the worker.

In contrast, in the outdoor unit 2, a label 40 indicating the refrigerant name is attached on the outer side of the cover 10. The cover 10 is a component that is inevitably detached when any of several kinds of work given above that involve the handling of the refrigerant is performed. That is, the cover 10 is a component that the worker never fails to see when any work is performed. Therefore, in the outdoor unit 2, the label 40 on which the refrigerant name is indicated is attached on the outer side of the cover 10, whereby the probability that the worker may overlook the indication of the refrigerant name when performing any work involving the handling of the refrigerant is reduced.

The label 40 may also have other pieces of information such as precaution in performing work and graphic symbols (such as a mark, initials, or the like representing that the refrigerant is flammable) to serve as warning sings, caution pointers or reminders, etc. Since the cover 10 covers the liquid-side pipe-connecting valve 8, the gas-side pipe-connecting valve 9, and the terminal block 17, the cover 10 has many flat areas suitable for attaching the label 40. Therefore, the refrigerant name can be indicated in large letters, and other pieces of information such as precaution in performing work and graphic symbols to serve as warning sings, caution pointers or reminders, etc. can also be provided.

The label 40 is attached in such a manner as to extend in two directions of the outdoor unit 2, for example, in a direction along the front face and in a direction along the lateral side face. While FIG. 6 illustrates a case where the label 40 is attached in such a manner as to extend in the directions along the front face and the lateral side face of the outdoor unit 2, the two directions of the outdoor unit 2 are not limited to the directions along the front face and the direction along the lateral side face, and may be a direction along the rear face and a direction along the lateral side face or a direction along the upper face and a direction along the lateral side face. Moreover, the label 40 may extend in three directions of the outdoor unit 2, for example, in directions along the front face, the lateral side face, and the rear face of the outdoor unit 2.

The direction in which the worker faces the cover 10 when detaching or attaching the cover 10 varies with the situation in which the outdoor unit 2 is installed. For example, if the side panel 66 is positioned close to a wall or the like of the building, the worker cannot put his/her body between the wall and the outdoor unit 2. Hence, the worker needs to handle the cover 10 from the front side of the outdoor unit 2. In such a case, a portion of the cover 10 that extends along the lateral side face of the outdoor unit 2 is difficult to see. Therefore, if the label 40 is attached in such a manner as to extend along the lateral side face of the outdoor unit 2, the label 40 tends to be overlooked.

On the other hand, if a wall or the like of the building is on the front side of the outdoor unit 2, the worker needs to handle the cover 10 from the lateral side of the outdoor unit 2. In such a case, a portion of the cover 10 that extends along the front face of the outdoor unit 2 is difficult to see. Therefore, if the label 40 is attached in such a manner as to extend along the front face of the outdoor unit 2, the label 40 tends to be overlooked.

Focusing on such characteristics of the work relating to the outdoor unit 2, the label 40 of the outdoor unit 2 is attached in such a manner as to extend in two directions of the outdoor unit 2. Thus, the probability that the label 40 may be overlooked depending on the situation in which the outdoor unit 2 is installed is reduced.

In the case where the label 40 is attached in such a manner as to extend in a plurality of directions of the outdoor unit 2, the label 40 may not necessarily be continuous. The label 40 may be divided into a plurality of portions, and the plurality of divided portions may be attached in such a manner as to extend in respective directions.

The label 40 is preferably made of, for example, a plastic printing sheet. The characters and graphics printed on the label 40 preferably have colors that provide high contrast with respect to the background. Moreover, the characters, the graphics, and the background may be provided in r a color or colors that attract the worker's attention. While the above description concerns a case where the label 40 is attached on the cover 10, the present invention is not limited to such a case. The characters, graphics, and so forth printed on the label 40 may be directly printed or formed as convex or concave characters (by metal molding or metal engraving) on the cover 10. In any case, since the cover 10 has many flat areas, the indication can be provided at any position of the cover 10. Moreover, in any case, the indication is preferably provided in such a manner as to extend in a plurality of directions of the outdoor unit 2.

Preferably, an additional label 40 is attached on the inner side of the cover 10. Thus, even if the worker has overlooked the label 40 attached on the outer side of the cover 10, the probability that the worker may notice the label 40 attached on the inner side of the cover 10 and see the refrigerant name, precaution in performing work, and graphic symbols or the like to serve as warning sings, caution pointers or reminders, etc. Is increased.

<Advantageous Effects Produced by Outdoor Unit 2>

As described above, in the outdoor unit 2, the label 40 on which the refrigerant name is indicated is attached on the outer side of the cover 10, which is a component that is inevitably detached when any work involving the handling of the refrigerant is performed. Therefore, the probability that the worker may overlook the indication of the refrigerant name when performing any work involving the handling of the refrigerant can be reduced. Hence, the probability that the worker may charge a wrong refrigerant when performing any work involving the handling of the refrigerant can be reduced, and the safety is increased. In addition, the deterioration in the performance and quality of the air-conditioning apparatus A is suppressed. In particular, if any of the flammable refrigerants such as R32 and R290 is used, the above advantageous effects are enhanced in terms of safety. Furthermore, such an aspect contributes to the suppression of global warming.

The label 40 is attached in such a manner as to extend in a plurality of directions of the outdoor unit 2 (to be visible in a plurality of directions of the outdoor unit 2). Therefore, even if the direction in which the worker faces the cover 10 varies with the situation in which the outdoor unit 2 is installed, the probability that the worker may overlook the indication of the refrigerant name when performing any work involving the handling of the refrigerant can be reduced.

While Embodiment 1 concerns an exemplary case where the air-conditioning apparatus A is applied to a separate-type home-use air-conditioner, the air-conditioning apparatus A is not limited to a separate-type home-use air-conditioner. The air-conditioning apparatus A is also applicable to an industrial air-conditioner, a refrigeration apparatus, and so forth as long as the refrigerant-charging charge port 23 is provided to the outdoor unit 2.

### Embodiment 2

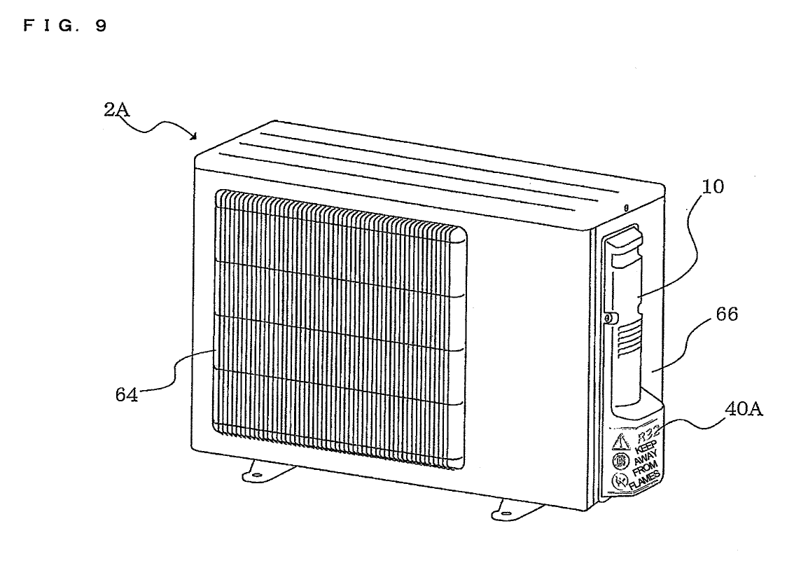

FIG. 9 is a perspective view illustrating the appearance of an outdoor unit 2A according to Embodiment 2 of the present invention. The outdoor unit 2A will now be described in detail with reference to FIG. 9. In Embodiment 2, elements the same as those described in Embodiment 1 are denoted by the corresponding reference numerals used in Embodiment 1, and differences from Embodiment 1 are mainly discussed.

The basic configuration of the outdoor unit 2A is the same as that of the outdoor unit 2 according to Embodiment 1. In the outdoor unit 2A also, the label 40 having at least an indication of the refrigerant name is attached on the cover 10. In addition, at least the refrigerant name is directly provided on the cover 10. Specifically, the characters and graphic symbols that are the same as those indicated on the label 40 are directly provided by metal molding, metal engraving, or the like in the area of the cover 10 where the label 40 is attached in Embodiment 1.

The indicated information such as characters and graphic symbols (hereinafter referred to as indicated information 40A) provided on the cover 10 may be exactly the same as that provided on the label 40 described in Embodiment 1, or may be made simpler and easier to recognize or more detailed than that provided on the label 40 described in Embodiment 1. The size of the indicated information 40A may be, but may not necessarily be, the same as that of the indication such as characters and graphic symbols provided on the label 40 described in Embodiment 1.

The indicated information 40A is provided in a concave shape on the outer side (the side on which the label 40 is to be attached) of the cover 10 by metal molding or metal engraving. In the case where the label 40 is attached on the outer side of the cover 10, if the indication such as characters and graphic symbols formed by metal molding or metal engraving are convex with respect to the surface on which the label 40 is to be attached, the surface for attaching the label 40 becomes less flat and less adhesive. Hence, the indicated information 40A is provided in a concave shape with respect to the surface of the cover 10. Thus, the flatness of the surface for attaching the label 40 is retained, and the reduction in the adhesiveness of the surface is suppressed.

Preferably, an additional label 40 is attached on the inner side of the cover 10. Thus, even if the worker has overlooked the label 40 attached on the outer side of the cover 10, the probability that the worker may notice the label 40 attached on the inner side of the cover 10 and see the refrigerant name, precaution in performing work, and graphic symbols or the like to serve as warning sings, caution pointers or reminders, etc. is increased.

<Advantageous Effects Produced by Outdoor Unit 2A>

The indication by using the label 40 described in Embodiment 1 is beneficial in that characters and graphic symbols can be printed in such a manner as to be noticeable for the worker in terms of color or contrast. Instead, the label 40 according to Embodiment 1 may peel off the cover 10 if the adhesiveness of the label 40 is reduced over time. Hence, the indicated information 40A including at least the refrigerant name is directly provided on the cover 10, and the label 40 is attached thereover. Thus, even if the label 40 peels off, necessary information is kept being indicated.

As described above, in addition to the benefit brought by attaching the label 40, the outdoor unit 2A is beneficial in that, even if the label 40 peels off, the probability that the worker may overlook the indication of the refrigerant name when performing any work involving the handling of the refrigerant can be reduced. Hence, over many years, the probability that the worker may charge a wrong refrigerant when performing any work involving the handling of the refrigerant can be reduced, whereby the safety is increased.

In the outdoor unit 2A, the indicated information 40A is provided in a concave shape with respect to the surface of the cover 10. Therefore, the flatness of the surface on which the label 40 is attached is retained, and the reduction in the adhesiveness of the surface is suppressed. Hence, the peeling of the label 40 is not accelerated by the presence of the indicated information 40A. In addition, the outdoor unit 2A also produces the advantageous effects produced by the outdoor unit 2 according to Embodiment 1, of course.

### Embodiment 3

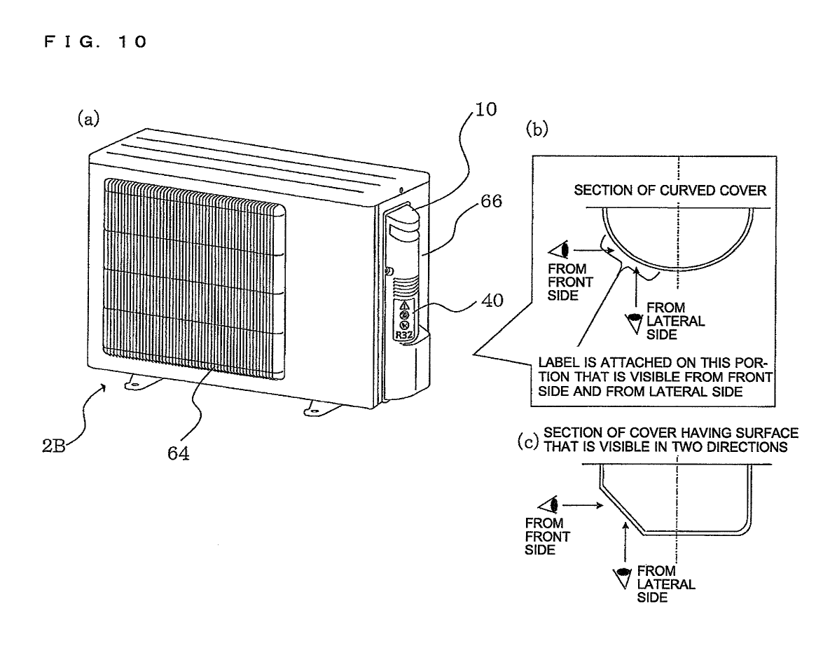

FIG. 10 illustrates an outdoor unit 2B according to Embodiment 3 of the present invention. The outdoor unit 2B will now be described in detail with reference to FIG. 10. FIG. 10 includes part (a) as a perspective view illustrating the appearance of the outdoor unit 2B, and parts (b) and (c) illustrating how the cover 10 of the outdoor unit 2B works. In Embodiment 3, elements the same as those described in Embodiments 1 and 2 are denoted by the corresponding reference numerals used in Embodiments 1 and 2, and differences from Embodiments 1 and 2 are mainly discussed.

The basic configuration of the outdoor unit 2B is the same as that of the outdoor unit 2 according to Embodiment 1. The cover 10 of the outdoor unit 2B has an improved shape. Specifically, as illustrated in FIG. 10(b), the cover 10 has a curved surface. Alternatively, as illustrated in FIG. 10(c), the cover 10 has a flat surface-like shape in a portion that is visible in a plurality of directions of the outdoor unit 2B.

In Embodiment 1, the label 40 is attached in such a manner as to extend in a plurality of directions of the outdoor unit 2 (to be visible in a plurality of directions of the outdoor unit 2). However, in Embodiment 1, no improvements are made in the shape of the cover 10. In contrast, the cover 10 according to Embodiment 3 has an improved shape that allows the label 40 attached thereon to be visible in a plurality of directions of the outdoor unit 2B.

For example, as illustrated in FIG. 10(b), the cover 10 has a curved surface, and the label 40 is attached on the curved surface. Thus, the label 40 is visible in two directions of the outdoor unit 2B, specifically, in a direction facing the front face and in a direction facing the lateral side face.

Alternatively, as illustrated in FIG. 10(c), the cover 10 has a flat surface-like shape in a portion that is visible in a plurality of directions of the outdoor unit 2B, and the label 40 is attached on the flat surface. Thus, the label 40 is visible in two directions of the outdoor unit 2B, specifically, in a direction facing the front face and in a direction facing the lateral side face.

The two directions of the outdoor unit 2B are not limited to the direction facing the front face and the direction facing the lateral side face, and may be a direction facing the rear face and a direction facing the lateral side face or a direction facing the upper face and a direction facing the lateral side face. Moreover, the label 40 may be attached in such a manner as to extend in three directions of the outdoor unit 2B, for example, in directions along the front face, the lateral side face, and the rear face. Furthermore, as described in Embodiment 2, characters, graphic symbols, and the like may be directly provided on the cover 10.

Preferably, an additional label 40 is attached on the inner side of the cover 10. Thus, even if the worker has overlooked the label 40 attached on the outer side of the cover 10, the probability that the worker may notice the label 40 attached on the inner side of the cover 10 and see the refrigerant name, precaution in performing work, and graphic symbols or the like to serve as warning sings, caution pointers or reminders, etc. Is increased.

<Advantageous Effects Produced by Outdoor Unit 2B>

As described above, the cover 10 of the outdoor unit 2B has an improved shape, and the label 40 can be attached at a position of the cover 10 that is visible in a plurality of directions of the outdoor unit 2B. Therefore, even if the direction in which the worker faces the cover 10 varies with the situation in which the outdoor unit 2B is installed, the probability that the worker may overlook the indication of the refrigerant name when performing any work involving the handling of the refrigerant can be reduced. Furthermore, since the single label 40 is visible in a plurality of directions, there is no need to provide indications of the same information for different directions, respectively, which is more efficient.

Of course, the outdoor unit 2B also produces the advantageous effects produced by the outdoor unit 2 according to Embodiment 1. If the characters, graphic symbols, and the like are directly provided on the cover 10 as in the case of the outdoor unit 2A according to Embodiment 2, the advantageous effects produced by the outdoor unit 2A according to Embodiment 2 are also produced.

### Embodiment 4

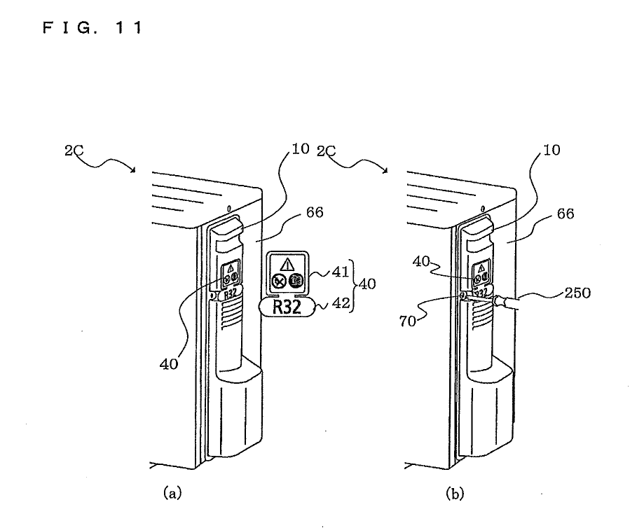

FIG. 11 illustrates an outdoor unit 2C according to Embodiment 4 of the present invention. The outdoor unit 2C will now be described in detail with reference to FIG. 11. FIG. 11 includes part (a) as a perspective view illustrating the appearance of the outdoor unit 2C, and part (b) illustrating how to attach/detach the cover 10 to/from the outdoor unit 2C. In Embodiment 4, elements the same as those described in any of Embodiments 1 to 3 are denoted by the corresponding reference numerals used in Embodiments 1 to 3, and differences from Embodiments 1 to 3 are mainly discussed.

The basic configuration of the outdoor unit 2C is the same as that of the outdoor unit 2 according to Embodiment 1. The label 40 of the outdoor unit 2C has an improved shape. Specifically, as illustrated as an enlarged view in FIG. 11(a), a portion of the label 40 is deformable. In Embodiments 1 to 3, the label 40 has been described as a member to be simply attached on the cover 10. In Embodiment 4, a portion of the label 40, specifically, a portion that faces the heads of screw members 70 used for fixing the cover 10 to the side panel 66, is deformable. More specifically, the label 40 includes a label main portion 41 that is attached on the cover 10, and a covering label portion 42 that hinders the access of the screw members 70 to the cover 10 when the cover 10 is attached or detached.

In FIG. 11, the refrigerant name is indicated on the covering label portion 42, and the heads of the screw members 70 are covered with the covering label portion 42. That is, while the label main portion 41 is attached on the cover 10, the covering label portion 42 is not attached on the cover 10 but is provided over a portion of the cover 10 that is screwed. The label 40 is deformable by, for example, folding the covering label portion 42. The label 40 is made of a flexible material such as a plastic printing sheet. The label main portion 41 and the covering label portion 42 may be provided as one integral member or as separate members. If the label main portion 41 and the covering label portion 42 are provided as separate members, the two may be made of different materials. For example, the covering label portion 42 may be made of a material (such as silicon or rubber) that is more flexible than the material of the label main portion 41.

The label 40 that is attached on the cover 10 includes the covering label portion 42. Therefore, as illustrated in FIG. 11(b), when the worker attempts to attach or detach the cover 10, the worker cannot access the screw members 70 unless the worker deforms the covering label portion 42 so as to expose the heads of the screw members 70. Thus, it becomes possible to more assuredly let the worker see the information indicated on the label 40. Furthermore, the covering label portion 42 is flexible. Therefore, if the force applied to the covering label portion 42 by the worker is removed, the covering label portion 42 restores its original form, that is, the covering label portion 42 comes to cover the heads of the screw members 70 again.

Preferably, an additional label 40 is attached on the inner side of the cover 10. Thus, even if the worker has overlooked the label 40 attached on the outer side of the cover 10, the probability that the worker may notice the label 40 attached on the inner side of the cover 10 and see the refrigerant name, precaution in performing work, and graphic symbols or the like to serve as warning sings, caution pointers or reminders, etc. is increased.

<Advantageous Effects Produced by Outdoor Unit 2C>

As described above, the outdoor unit 2C has the label 40 that includes the covering label portion 42. Therefore, to attach or detach the cover 10, the worker needs to first deform the covering label portion 42 before removing the screw members 70 by using a tool 250. That is, the worker is forced to deform the covering label portion 42. Thus, it is possible to more assuredly let the worker pay attention to the label 40. Consequently, it is possible to assuredly let the worker carefully see the refrigerant name when the worker performs any work involving the handling of the refrigerant.

The label 40 is made of a flexible material. Therefore, even if the covering label portion 42 is deformed, the covering label portion 42 restores its original form and covers the screw members 70 again when the force applied to the covering label portion 42 by the worker is removed. Hence, in the state where the cover 10 is on the outdoor unit 2C after the completion of the work, the screw members 70 are covered with the covering label portion 42 again. Therefore, in every work to be performed thereafter also, it is possible to let the worker pay attention to the label 40 in the same way.

Any of the features described in Embodiments 1 to 3 may also be applied to the outdoor unit 2C according to Embodiment 4. If any of the features described in Embodiments 1 to 4 are appropriately combined, corresponding ones of the advantageous effects produced in Embodiments 1 to 4 are enhanced by one another.

### Embodiment 5

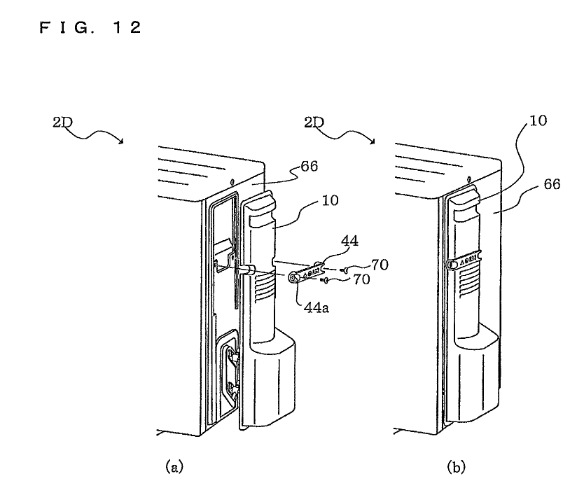

FIG. 12 illustrates an outdoor unit 2D according to Embodiment 5 of the present invention. The outdoor unit 2D will now be described in detail with reference to FIG. 12. FIG. 12 includes part (a) illustrating how to attach/detach the cover 10 to/from the outdoor unit 2D, and part (b) as a perspective view illustrating the appearance of the outdoor unit 2D. In Embodiment 5, elements the same as those described in any of Embodiments 1 to 4 are denoted by the corresponding reference numerals used in Embodiments 1 to 4, and differences from Embodiments 1 to 4 are mainly discussed.

The basic configuration of the outdoor unit 2D is the same as that of the outdoor unit 2 according to Embodiment 1. The cover 10 of the outdoor unit 2D is attached in an improved method. Specifically, as illustrated in FIG. 12(a), a fixing member 44 that extends across the cover 10 is prepared, and the cover 10 is fixed to the side panel 66 with the aid of the fixing member 44. More specifically, a fixing member 44 that extends across the cover 10 is prepared. Screw holes 44a are provided at two ends of the fixing member 44, the two ends facing the heads of the screw members 70, respectively, the screw members 70 being used when the cover 10 is fixed to the side panel 66. Thus, the cover 10 is fixed to the side panel 66 with the aid of the fixing member 44.

The fixing member 44 extends across the cover 10 in the width direction of the cover 10 and is screwed to the outdoor unit 2D while pressing the cover 10. That is, the cover 10 cannot be attached to the side panel 66 with a satisfactory strength unless the fixing member 44 is provided. Hence, the label 40 is attached on the fixing member 44.

Caution in performing work and graphic symbols or the like to serve as warning sings, caution pointers or reminders, etc. may also be provided on the label 40. Moreover, a label 40 made of, for example, a plastic printing sheet may be attached on the fixing member 44; the information indicated on the label 40 may be directly printed on the fixing member 44; or the information indicated on the label 40 may be provided as convex or concave characters (by metal molding or metal engraving) in the fixing member 44.

Preferably, an additional label 40 is attached on the inner side of the cover 10. Thus, even if the worker has overlooked the label 40 attached on the outer side of the cover 10, the probability that the worker may notice the label 40 attached on the inner side of the cover 10 and see the refrigerant name, precaution in performing work, and graphic symbols or the like to serve as warning sings, caution pointers or reminders, etc. is increased.

<Advantageous Effects Produced by Outdoor Unit 2D>

As described above, to attach or detach the cover 10 to or from the outdoor unit 2D, the worker needs to remove the fixing member 44 on which the label 40 is attached. Therefore, it is possible to more assuredly let the worker pay attention to the label 40. Consequently, it is possible to assuredly let the worker carefully see the refrigerant name when the worker performs any work involving the handling of the refrigerant. Furthermore, to attach the cover 10 after the work is complete, the fixing member 44 on which the label 40 is attached is necessary. Hence, the label 40 is assuredly put back to its original position. Therefore, in every work to be performed thereafter also, it is possible to let the worker pay attention to the label 40 in the same way.

Any of the features described in Embodiments 1 to 3 may also be applied to the outdoor unit 2D according to Embodiment 5. If any of the features described in Embodiments 1 to 3 and 5 are appropriately combined, corresponding ones of the advantageous effects produced in Embodiments 1 to 3 and 5 are enhanced by one another.

### Embodiment 6

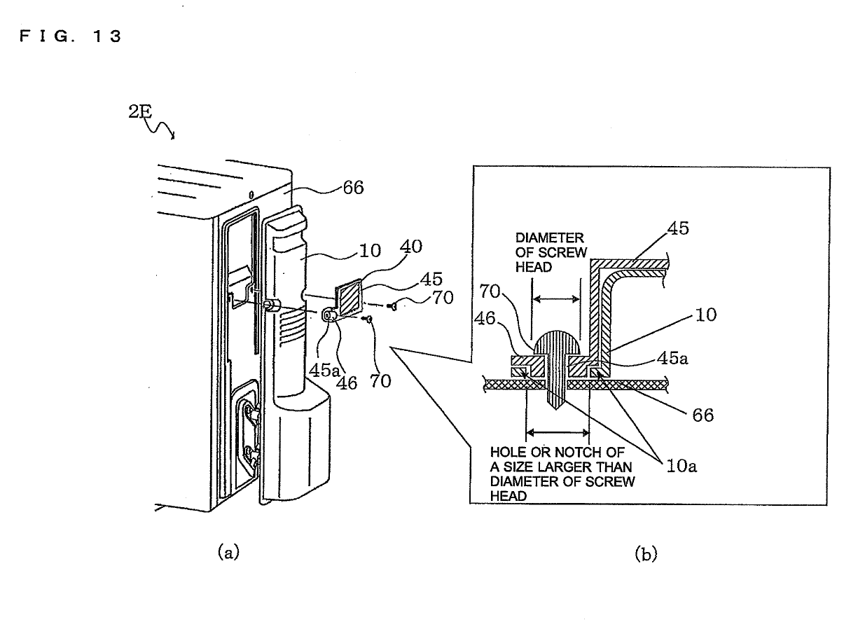

FIG. 13 illustrates an outdoor unit 2E according to Embodiment 6 of the present invention. The outdoor unit 2E will now be described in detail with reference to FIG. 13. FIG. 13 includes part (a) illustrating how to attach/detach the cover 10 to/from the outdoor unit 2E, and part (b) as an enlarged transverse sectional view illustrating a part where the cover 10 is fixed. In Embodiment 6, elements the same as those described in any of Embodiments 1 to 5 are denoted by the corresponding reference numerals used in Embodiments 1 to 5, and differences from Embodiments 1 to 5 are mainly discussed.

The basic configuration of the outdoor unit 2E is the same as that of the outdoor unit 2 according to Embodiment 1. The cover 10 of the outdoor unit 2E is attached in an improved method. Specifically, as illustrated in FIG. 13(a), a fixing member 45 has a screw holding portion 46 that fits in an edge portion 10a of the cover 10, and the cover 10 is fixed to the side panel 66 with the aid of the fixing member 45. More specifically, the screw holding portion 46 having a screw hole 45a is provided at one end (on the left side in the drawings) of the fixing member 45, the one end facing the head of one of the screw members 70 used for fixing the cover 10 to the side panel 66. Thus, the cover 10 is fixed to the side panel 66 with the aid of the fixing member 45.

The screw holding portion 46 is fitted in the edge portion 10a of the cover 10. The hole (or a notch) in which the screw holding portion 46 is fitted has a size that is larger than the diameter of the head of the screw member 70 used for attaching the cover 10 to the side panel 66. Hence, in a case where the fixing member 45 is not provided, the head of the screw member 70 is not caught by the edge portion 10a of the cover 10. Therefore, the cover 10 cannot be attached to the side panel 66. That is, the cover 10 cannot be attached to the side panel 66 with a satisfactory strength unless the fixing member 45 is provided. Hence, the label 40 is attached on the fixing member 45.

Caution in performing work and graphic symbols or the like to serve as warning sings, caution pointers or reminders, etc. may also be provided on the label 40. Moreover, a label 40 made of, for example, a plastic printing sheet may be attached on the fixing member 45; the information provided on the label 40 may be directly printed on the fixing member 45; or the information provided on the label 40 may be provided as convex or concave characters (by metal molding or metal engraving) in the fixing member 45.

On a side of the cover 10 on which no portion for receiving the screw holding portion 46 is provided, the cover 10 is preferably directly attached to the side panel 66 with the screw member 70. Alternatively, the screw holding portion 46 may be provided at each of the two ends of the fixing member 45. In that case, as in Embodiment 5, the cover 10 cannot be attached to the side panel 66 with a satisfactory strength unless the fixing member 45 is provided.

Preferably, an additional label 40 is attached on the inner side of the cover 10. Thus, even if the worker has overlooked the label 40 attached on the outer side of the cover 10, the probability that the worker may notice the label 40 attached on the inner side of the cover 10 and see the refrigerant name, precaution in performing work, and graphic symbols or the like to serve as warning sings, caution pointers or reminders, etc. is increased.

<Advantageous Effects Produced by Outdoor Unit 2E>

As described above, to attach or detach the cover 10 to or from the outdoor unit 2E, the worker needs to remove the fixing member 45 on which the label 40 is attached. Therefore, it is possible to more assuredly let the worker pay attention to the label 40. Consequently, it is possible to assuredly let the worker carefully see the refrigerant name when the worker performs any work involving the handling of the refrigerant. Furthermore, to attach the cover 10 after the work is complete, the fixing member 45 on which the label 40 is attached is necessary. Hence, the label 40 is assuredly put back to its original position. Therefore, in every work to be performed thereafter also, it is possible to let the worker pay attention to the label 40 in the same way.

Any of the features described in Embodiments 1 to 3 may also be applied to the outdoor unit 2E according to Embodiment 6. If any of the features described in Embodiments 1 to 3 and 6 are appropriately combined, corresponding ones of the advantageous effects produced in Embodiments 1 to 3 and 6 are enhanced by one another.

### Embodiment 7

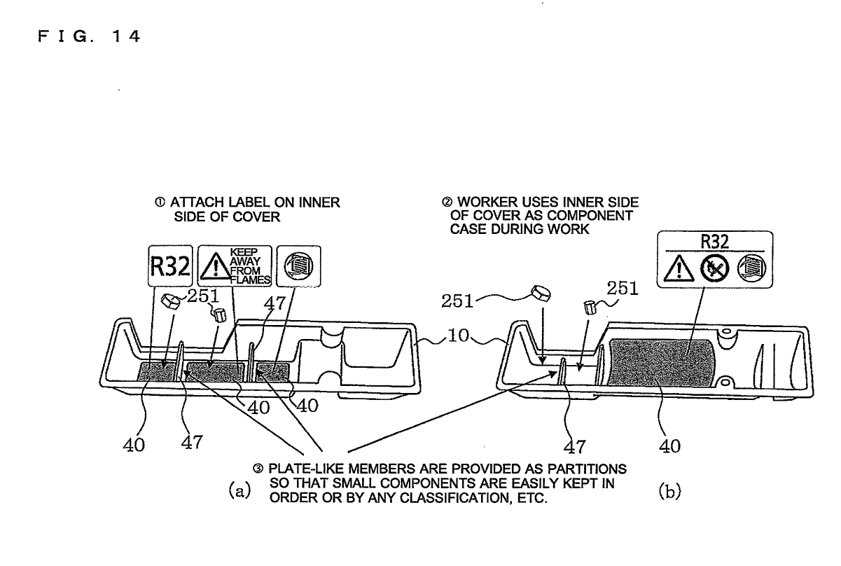

FIG. 14 illustrates a cover 10 to be attached to an outdoor unit according to Embodiment 7 of the present invention. The outdoor unit according to Embodiment 7 will now be described in detail with reference to FIG. 14. FIG. 14 includes part (a) schematically illustrating the inner side of an exemplary cover 10 to be attached to the outdoor unit according to Embodiment 7, and part (b) schematically illustrating the inner side of another exemplary cover 10 to be attached to the outdoor unit according to Embodiment 7. In Embodiment 7, elements the same as those described in any of Embodiments 1 to 6 are denoted by the corresponding reference numerals used in Embodiments 1 to 6, and differences from Embodiments 1 to 6 are mainly discussed.

The basic configuration of the outdoor unit according to Embodiment 7 is the same as that of the outdoor unit 2 according to Embodiment 1. In the outdoor unit according to Embodiment 7, the inner side of the cover 10 has an improved structure. In Embodiments 1 to 6, an additional label 40 is preferably attached on the inner side of the cover 10. In Embodiment 7, at which position on the inner side of the cover 10 the label 40 is to be attached is specified.

The cover 10 is a component that is inevitably detached when the air-conditioning apparatus A is installed or removed or when any work involving the handling of the refrigerant, such as the charging of the refrigerant, is performed. Furthermore, the cover 10 is a component that is inevitably attached after the work is complete. Therefore, the cover 10 tends to be put in the vicinity of the worker during work. Moreover, many workers often put the cover 10 with the inner side thereof facing upward and use the cover 10 as a component case so that small components such as screws, nuts, and caps (hereinafter referred to as small components 251) that are disassembled from the outdoor unit during work are not lost.

Hence, if the label 40 is attached on the inner side of the cover 10 taking the worker's behavior into consideration, it becomes easy for the worker to recognize the refrigerant name when the worker performs any work involving the handling of the refrigerant. Since the cover 10 is intended to cover the liquid-side pipe-connecting valve 8, the gas-side pipe-connecting valve 9, and the terminal block 17, the cover 10 has many flat areas also on the inner side. Furthermore, since the cover 10 has an area large enough to attach the label 40, not only the refrigerant name but also precaution in performing work and graphic symbols can also be indicated.

For example, FIG. 14(a) illustrates a case where plate-like members 47 are provided on the inner side of the cover 10 so as to allow the worker to easily keep in order the small components 251 disassembled during work. In such a case, the label 40 is preferably attached on the surface of at least one of the areas separated by the plate-like members 47. The plate-like members 47 referred to herein may each have, but are each not limited to have, any shape as long as the area on the inner side of the cover 10 can be sectioned. Preferably, the label 40 is divided into a plurality of pieces in accordance with the sizes of the areas on which the label 40 can be attached.

Alternatively, as illustrated in FIG. 14(b), in a case where there is still a large area for attaching the label 40 even if any plate-like members 47 are provided, the label 40 is preferably attached on that large area on the inner side of the cover 10. In such a case, the label 40 can be attached without being divided into pieces.

Caution in performing work and graphic symbols or the like to serve as warning sings, caution pointers or reminders, etc. may also be provided on the label 40. Moreover, a label 40 made of, for example, a plastic printing sheet may be attached on the inner side of the cover 10; the information provided on the label 40 may be directly printed on the inner side of the cover 10; or the information provided on the label 40 may be provided as convex or concave characters (by metal molding or metal engraving) on the inner side of the cover 10.

<Advantageous Effects Produced by Outdoor Unit According to Embodiment 7>

As described above, in the outdoor unit according to Embodiment 7, the label 40 is attached on the inner side of the cover 10. During the work of attaching/detaching the cover 10, the worker puts the cover 10 in the vicinity of him/her such that the inner side of the cover 10 faces upward. Therefore, it is possible to assuredly let the worker pay attention to the label 40. Consequently, it is possible to assuredly let the worker carefully see the refrigerant name when the worker performs any work involving the handling of the refrigerant.

Workers often use the cover 10 that is put with the inner side thereof facing upward as a component case for putting the small components 251. Therefore, the convenience for the worker can be increased by, for example, sectioning the area on the inner side of the cover 10 with the plate-like members 47 so that the small components 251 can be put therein in an orderly manner. Furthermore, providing the plate-like members 47 can induce the behaviors such as putting the small components 251 in an orderly manner more than ever. Thus, the probability of overlooking of the label 40 on the inner side of the cover 10 can be reduced.

Any of the features described in Embodiments 1 to 6 may also be applied to the outdoor unit according to Embodiment 7. If any of the features described in Embodiments 1 to 7 are appropriately combined, corresponding ones of the advantageous effects produced in Embodiments 1 to 7 are enhanced by one another.

### Embodiment 8

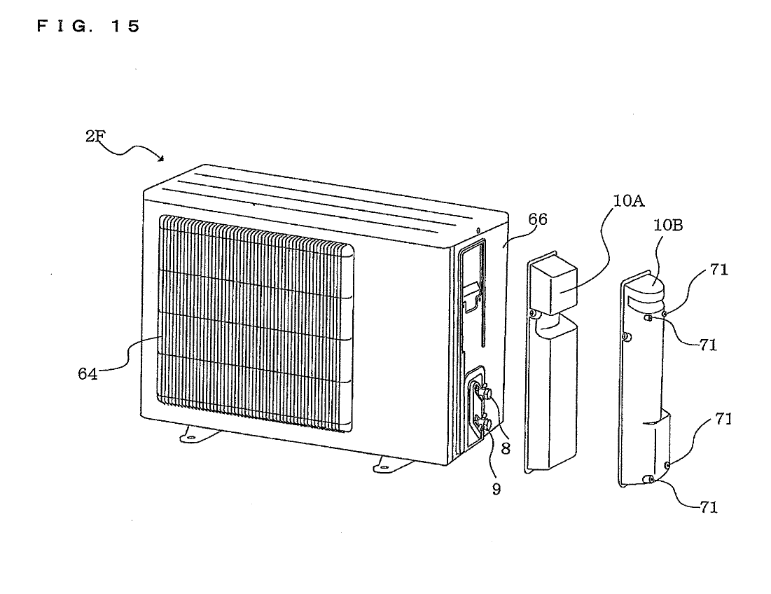

FIG. 15 illustrates an outdoor unit 2F according to Embodiment 8 of the present invention. The outdoor unit 2F will now be described in detail with reference to FIG. 15. In FIG. 15, two kinds of covers 10 are illustrated. In Embodiment 8, elements the same as those described in any of Embodiments 1 to 7 are denoted by the corresponding reference numerals used in Embodiments 1 to 7, and differences from Embodiments 1 to 7 are mainly discussed.

The basic configuration of the outdoor unit 2F is the same as that of the outdoor unit 2 according to Embodiment 1. In the outdoor unit 2F, the outer side of the cover 10 has an improved structure. In Embodiment 7, at which position on the inner side of the cover 10 the label 40 is to be attached is specified. In Embodiment 8, the structure on the outer side of the cover 10 has been improved such that the entirety of the cover 10 is stabilized when the cover 10 is put with the inner side thereof facing upward and the outer side thereof facing downward.

As described in Embodiment 7, the cover 10 tends to be put with the inner side thereof facing upward in the vicinity of the worker during work. Moreover, workers often use the cover 10 that has been put as described above as a component case so that the small components 251 such as screws, nuts, and caps that are disassembled from the outdoor unit during work are not lost. In such a case, if the cover 10 is instable and rolls over, the small components 251 may be lost. In the outdoor unit 2E, the label 40 is supposed to be attached on the inner side of the cover 10.

Hence, in the outdoor unit 2F, the outer side of the cover 10 has a flat surface-like shape or a plurality of projections. For example, referring to FIG. 15, if the cover 10 is provided in the form of a cover 100A having a flat surface on the outer side thereof, the cover 10 can have a satisfactory area of contact when put with the inner side thereof facing upward. Therefore, the cover 10 can be put in a stable state. The cover 10 may not necessarily have a flat surface extending over the entirety of the outer side thereof. For example, in the case where the cover 10 has a curved surface as illustrated in FIG. 10, any portion other than the curved portion can be made flat.

Alternatively, as with a cover 10B illustrated in FIG. 15, if the cover 10 has a plurality of projections 71 on the outer side thereof, the projections 71 function as legs and retain the cover 10 in a predetermined state, for example, horizontally, with respect to the place where the cover 10 has been put with the inner side thereof facing upward. Thus, the cover 10 can be put stably. The projections 71 are suitable for, for example, the cover 10 having a curved surface as illustrated in FIG. 10.

While Embodiment 8 concerns an exemplary case where a flat surface or the projections 71 are employed so that the cover 10 can be put stably, the present invention is not limited to such a case. The cover 10 may have any other shape as long as the cover 10 can be put stably. In the case where the cover 10 has a flat surface-like shape on the outer side thereof, the flat surface may be divided into a plurality of flat portions. The plurality of flat portions do not need to be provided in correspondence with the structure on the inner side of the cover 10. In the case where the cover 10 has the projections 71 on the outer side thereof, at least three projections 71 only need to be provided, although the number of projections 71 is not limited. While the lengths of the projections 71 are not limited, the tips of the projections 71 are preferably aligned, taking the stability of the cover 10 into consideration.

In either case, the flat surface or the projections 71 may be provided as part of the cover 10 or as members separate from the cover 10 and to be attached to the cover 10.

<Advantageous Effects Produced by Outdoor Unit 2F>

As described above, in the outdoor unit 2F, the outer side of the cover 10 has a structure that allows the cover 10 to be put stably. Therefore, the worker can use the cover 10 as a component case in a more reliable way. This further induces the behaviors such as putting the small components 251 in the cover 10 in an orderly manner. Consequently, the probability of overlooking of the label 40 on the inner side of the cover 10 can be further reduced. Thus, it is possible to assuredly let the worker carefully see the refrigerant name when the worker performs any work involving the handling of the refrigerant.

Any of the features described in Embodiments 1 to 7 may also be applied to the outdoor unit 2F. If any of the features described in Embodiments 1 to 8 are appropriately combined, corresponding ones of the advantageous effects produced in Embodiments 1 to 8 are enhanced by one another.

### REFERENCE SIGNS UST

1: indoor unit, 2: outdoor unit, 2A: outdoor unit, 2B: outdoor unit, 2C: outdoor unit, 2D: outdoor unit, 2E: outdoor unit, 3: compressor, 4: four-way valve, 5: outdoor heat exchanger, 6: flow rate control device, 7: extension pipe, 8: liquid-side pipe-connecting valve, 9: gas-side pipe-connecting valve, 10: cover, 10A: cover, 10B: cover, 10a: edge portion, 11: indoor heat exchanger, 12: liquid-side pipe-connecting joint, 13: gas-side pipe-connecting joint, 14: driving device, 15: outdoor blower motor, 16: outdoor fan, 17: terminal block, 18: indoor blower motor, 19: blower fan, 20: terminal block, 21: installation plate, 22: VVF cable, 23: refrigerant-charging charge port, 24: sealing hexagonal nut, 25: vacuum pump, 26: charge hose, 27: pressure gauge, 28: valve-rod hexagonal nut, 29: hexagonal wrench, 30: gas-pipe-side valve rod, 31: valve-rod hexagonal nut, 32: liquid-pipe-side valve rod, 33: valve, 40: label, 40A: indicated information, 41: label main portion, 42: covering label portion, 44: fixing member, 44a: screw hole, 45: fixing member, 45a: screw hole, 46: screw holding portion, 47: plate-like member, 51: supporting block, 52: base, 53: electric component box, 54: casing, 55: front design panel, 56: indoor-side driving device, 57: air inlet, 58: air outlet, 59: screw, 60: heat insulator, 61: tape, 62: panel, 63: opening, 64: fan guard, 65: top plate, 66: side panel, 67: cable cover, 68: opening, 70: screw member, 71: projection, 200: outdoor unit, 201: outdoor unit, 210: cover, 220: product identification label, 223: charge port, 250: tool, 251: small component, A: air-conditioning apparatus

1. An outdoor unit comprising a cover attached to a side panel thereof,
wherein at least a name of a refrigerant used in the outdoor unit is indicated on at least one of an outer side and an inner side of the cover.

2. The outdoor unit of claim 1,
wherein the name of the refrigerant is indicated on the outer side or the inner side of the cover by attaching a label, on which the name of the refrigerant is provided, on the outer side or the inner side of the cover.

3. The outdoor unit of claim 2,
wherein at least the name of the refrigerant used is engraved on the outer side of the cover on which the label is attached.

4. The outdoor unit of claim 3,
wherein, in a case where at least the name of the refrigerant is engraved, the name of the refrigerant is engraved in a concave shape.

5. The outdoor unit of claim 1,
wherein, in a case where the name of the refrigerant is indicated on the outer side of the cover,
the name of the refrigerant is indicated in such a manner as to extend in two directions of the outdoor unit.

6. The outdoor unit of claim 1,
wherein, in a case where the name of the refrigerant is indicated on the outer side of the cover,
the cover has a curved surface; and
the name of the refrigerant is visible in two directions of the outdoor unit.

7. The outdoor unit of claim 1,
wherein, in a case where the name of the refrigerant is indicated on the outer side of the cover,
a portion of the cover has a flat surface-like shape by which it is visible in two directions of the outdoor unit; and
the name of the refrigerant is indicated on the portion of the flat surface-like shape.

8. The outdoor unit of claim 2,
wherein, in a case where the label is attached on the outer side of the cover,
the label includes a covering label portion that is deformable; and
the covering label portion covers a screwed portion of the cover.

9. The outdoor unit of claim 1,
wherein, in a case where the name of the refrigerant is indicated on the outer side of the cover,
the outdoor unit includes a fixing member that extend across the cover and fixes the cover to the side panel; and
the name of the refrigerant is indicated on the fixing member.

10. The outdoor unit of claim 1,
wherein, in a case where the name of the refrigerant is indicated on the outer side of the cover,
the outdoor unit includes a fixing member having a screw holding portion that fits in an edge portion of the cover, the fixing member fixing the cover to the side panel; and
the name of the refrigerant is indicated on the fixing member.

11. The outdoor unit of claim 10,
wherein the edge portion has a hole in which the screw holding portion is fitted, and
wherein the hole has
a larger diameter than a head of a screw member that is used when the cover is attached to the side panel.

12. The outdoor unit of claim 2,
wherein, in a case where the label is attached on the inner side of the cover,
the label is attached on a portion of the cover that functions as a component case for any components that have been disassembled during work.

13. The outdoor unit of claim 12,
wherein a plate-like member is provided on the inner side of the cover, and the label is attached on at least one of surfaces of areas that are separated by the plate-like member.

14. The outdoor unit of claim 12,
wherein, in a case where the label is attached on the inner side of the cover,
at least a portion on the outer side of the cover has a flat surface-like shape.

15. The outdoor unit of claim 12,
wherein, in a case where the label is attached on the inner side of the cover,
the cover has a plurality of projections on the outer side.

16. The outdoor unit of claim 1,
wherein, in addition to the name of the refrigerant, precaution in performing work is indicated on at least one of the outer side and the inner side of the cover.

17. An air-conditioning apparatus comprising an outdoor unit and an indoor unit,
the outdoor unit comprising a cover attached to a side panel thereof,
wherein at least a name of a refrigerant used in the outdoor unit is indicated on at least one of an outer side and an inner side of the cover,
and
the indoor unit being connected to the outdoor unit.
